(19) United States
(12) Patent Application Publication
(10) Pub. No.: US 2009/0094882 A1
(43) Pub. Date: Apr. 16, 2009

(54) POWERED TRIGGER SYSTEM FOR CAGE-TYPE ANIMAL TRAPS

(76) Inventor: James Comstock, Gansevoort, NY (US)

Correspondence Address: SCHMEISER, OLSEN & WATTS, 22 CENTURY HILL DRIVE, SUITE 302, LATHAM, NY, 12110, US

(21) Appl. No.: 11/873,409

(22) Filed: Oct. 16, 2007

(51) Int. Cl. A01M 23/18; A01M 23/00

(52) U.S. Cl. 43/61

(57) ABSTRACT

A power trigger system for cage-type animal traps includes a catch member, a movable latch and a spring operable between the catch mechanism and the latch feature to exert a force tending the latch feature toward powered disengagement from the cage door. A corresponding method of triggering a cage trap to catch an animal is provided.

### BACKGROUND OF THE INVENTION

1. Technical Field

The present invention generally relates to animal traps. More particularly, the present invention relates to a powered trigger system for cage-type animal traps.

2. Related Art

Cage trapping is an old and well-known pursuit, which involves enticing an animal to enter a cage, wherein the animal becomes trapped when a trigger mechanism is actuated by the animal while inside the cage thereby closing cage doors and locking the animal in. Typically cages are shaped like a box. Some cages have one door and other cages have two doors located on opposite ends of the typical box-like structure so that an animal can look straight through the cage when the doors are in an open position. Cage doors are generally designed to swing or slide shut into a locked position that can not be unlocked by an animal. The closing of the doors can be powered, wherein springs or other mechanisms can assist the movement of the doors making them slam shut very quickly and powerfully, additionally the doors may close due to gravitational forces.

Various trigger mechanisms have been utilized to actuate closing of cage doors. A basic trigger system may utilize a string placed in the cage and attached to a door release latch. The string typically has bate attached to it so that when an animal grabs or moves the bate the string is associatively tugged thereby moving the door release latch and allowing the door to freely close. Other trigger systems utilize pans or trays that have been placed on the bottom of a cage and rigged to effectuate door closing when an animal steps on the pan or removes bate from the tray thereby altering the balance of the pan or tray and moving a connected door release mechanism or latch so that the door can close. In addition, cage door trigger systems have included wire cam triggers that utilize a thin wire member positioned so as to hang down into the middle of the cage or otherwise protrude into the interior volume of the cage so that an animal will likely contact the wire member when inside the cage an thereby cause the wire to move. The wire members are generally thin and designed to appear non-threatening to an animal. The wire members are usually attached to a cam member that can rotate when the wire members are moved. The cam member is operable with a pawl, dog component, or other engaging device serving as a catch mechanism and connected to a door release component such as a latch. Thus, when the wire members are moved, the connected cam member acts upon the pawl or catch and moves it to an unengaged position so that the connected door release mechanism becomes unlatched and the doors are free to move and close shut. Further trigger systems have utilized a lug attached to wire-like members that are pivotally attached to a support rod of the cage. When the wire-like members are moved the lug correspondingly moves and acts upon a pawl or catch attached to a spring. The other side of the spring is attached to a hinged latch. Hence, when the pawl or catch is disengaged by operable contact with the lug, the spring has no more tension on it to hold the connected latch in place and the hinged latch may rotate allowing a door to swing shut.

Of all the various known trigger mechanisms a generalized problem exists in that although the various triggers may be set to be extremely sensitive to triggering by animal contact, the operation of the triggers, once triggered, to disengage corresponding door latches is sometimes not fast enough to keep the animal from escaping. The known triggers systems often rely on gravity to move latch components after triggering or are reliant upon operable movement of the doors against or with the latch mechanism. No provision is made in the known triggering systems to physically speed up disengagement of the various door latch mechanisms once the trigger has been triggered. Accordingly, a need exists for providing a powered trigger system for cage-type animal traps.

### SUMMARY OF THE INVENTION

The present invention provides a powered trigger system for cage-type animal traps, which, when triggered, physically speeds up disengagement of cage doors for faster cage closure.

A first aspect of the invention provides a powered trigger apparatus for cage-type animal traps, the trigger apparatus comprising: a wire member, protruding into the interior volume of a cage; a pivotal cam component, connected to the wire member; a catch mechanism, configured to physically engage a structural element of the cage, the catch mechanism being in operable contact with the cam component so that the catch mechanism becomes disengaged from the structural element of the cage when the wire member is moved causing the cam component to pivot and move the catch mechanism out of its engaged position; a movable latch feature, configured to physically engage a portion of a door of the trap to secure the door in an open position, the latch feature operably connected to the catch mechanism so that the latch feature becomes disengaged from the door allowing the door to close when the catch mechanism becomes disengaged from the structural element of the cage; and a spring, operable between the catch mechanism and the latch feature to exert a force tending the latch feature toward powered disengagement from the cage door when the catch mechanism is disengaged from the structural element of the cage.

A second aspect of the invention provides a cage-type animal trap comprising: a cage, having an interior volume; a door of the cage, the door movable between an open position and a closed position; and a trigger device, operable to release the door from the open position and permit movement of the door to the closed position, the trigger device including: a movable door release component, configured to hold the door in the open position; an actuator, wherein a portion of the actuator resides within the interior volume of the cage; a catch mechanism, operably connected to the door release component to move the door release component when the actuator moves the catch mechanism to non-set position; and a resilient force exerting member, operably positioned to exert a release force on the door release component to speed up release of the door when the catch mechanism is in the non-set position.

A third aspect of the invention provides a method of using a cage trap to catch an animal, the method comprising: providing a cage trap, having movable door sized to permit entry of an animal into the cage trap when the door is in an open position, wherein the cage trap includes a triggering apparatus including: an actuator, protruding into the interior volume of the cage trap; a catch mechanism, configured to physically engage a structural element of the cage trap in a set state, the catch mechanism being in operable contact with the actuator so that the catch mechanism becomes disengaged from the structural element of the cage trap when the actuator is moved causing the catch mechanism to move to a non-set state; a movable latch, configured to physically engage a portion of a door of the cage trap to secure the door in an open position, the latch operably connected to the catch mechanism so that the latch becomes disengaged from the door allowing the door to close when the catch mechanism is in the non-set state; and a spring, operably positioned to exert a release force on the latch to power disengagement of the latch from the door speeding up free movement of the door when the catch mechanism is in the non-set state; allowing an animal to enter the cage trap; and capturing the animal when the animal contacts the actuator thereby initiating the trigger, wherein the contacted actuator moves the catch mechanism to a non-set state and the connected latch quickly releases the door as the spring exerts a release force causing the latch to forcibly disengage and speedily allow the door to freely close thereby shutting the animal inside the cage trap.

### BRIEF DESCRIPTION OF THE DRAWINGS

Some of the embodiments of this invention will be described in detail, with reference to the following figures, wherein like designations denote like members, wherein:

FIG. 1 depicts a side perspective view of an embodiment of a cage-type animal trap, in accordance with the present invention;

FIG. 2 depicts a partial cut-away perspective view of an embodiment of a door of an embodiment a cage-type animal trap, the door being in a closed position, in accordance with the present invention;

FIG. 3 depicts a partial cut-away side perspective view of an embodiment of a door of an embodiment a cage-type animal trap, the door being in an open position, in accordance with the present invention;

FIG. 4 depicts a cut-away side perspective view of a first embodiment of a powered trigger apparatus of an embodiment of a cage-type animal trap, in accordance with the present invention;

FIG. 5a depicts a side perspective view of an embodiment of an actuator of an embodiment of a powered trigger apparatus of an embodiment of a cage-type animal trap, in accordance with the present invention;

FIG. 5b depicts a side view of an embodiment of an actuator of an embodiment of a powered trigger apparatus of an embodiment of a cage-type animal trap, in accordance with the present invention;

FIG. 6 partial cut-away side perspective view of an embodiment of a catch mechanism prior to positioning in a set state in engagement with an actuator of an embodiment of a powered trigger apparatus of an embodiment of a cage-type animal trap, in accordance with the present invention;

FIG. 7 depicts a cut-away side perspective view of a second embodiment of a powered trigger apparatus of an embodiment of a cage-type animal trap, in accordance with the present invention;

FIG. 8 depicts a cut-away side perspective view of a third embodiment of a powered trigger apparatus of an embodiment of a cage-type animal trap, in accordance with the present invention;

FIG. 9 depicts a cut-away side perspective view of a fourth embodiment of a powered trigger apparatus of an embodiment of a cage-type animal trap, in accordance with the present invention;

FIG. 10 depicts a partial cut-away side perspective view of an embodiment of a catch mechanism prior to positioning in a set state in engagement with an actuator of the fourth embodiment of a powered trigger apparatus of an embodiment of a cage-type animal trap, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply for exemplary purposes in depicting a possible embodiment or embodiments of the present invention. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

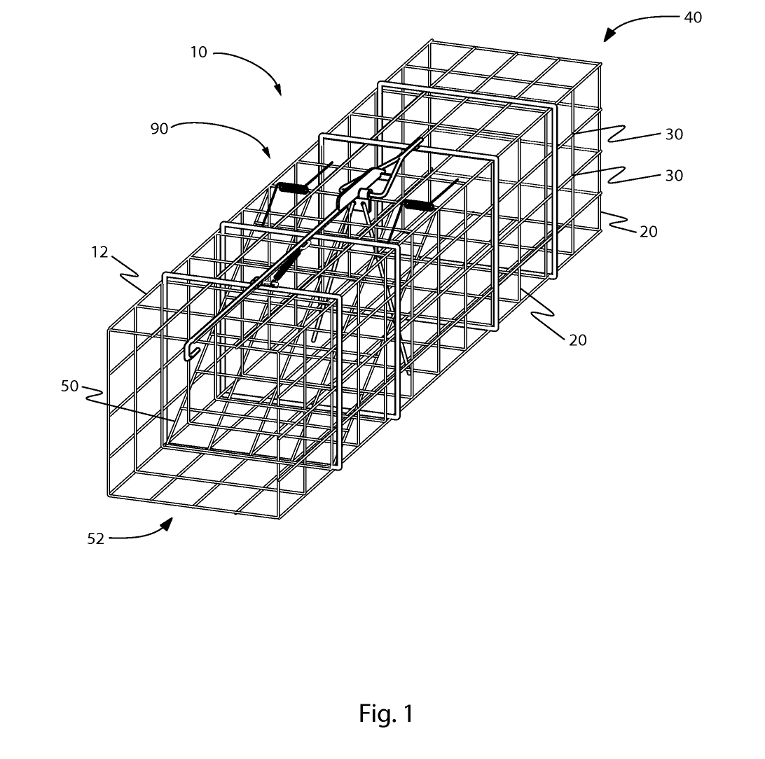

With reference to the drawings, FIG. 1 depicts a side perspective view of an embodiment of a cage-type animal trap 10. The cage-type trap 10 is formed generally in the shape of a box. However, those in the art should appreciate that traps may have any shape that has an interior volume large enough to house an animal to be trapped. Furthermore, the cage-type trap 10 includes a housing 12 fashioned of a mesh, grating or otherwise crisscrossed pattern of multiple structural elements 20 linked together at intersecting junctions 30 to form a cage. The gaps in the grating should be small enough to prevent an animal trapped inside from significantly extending appendages therethrough. The cage-type trap 10 includes a powered trigger apparatus 90. In addition, the cage-type trap 10 includes a door 50. As depicted, door 50 is located in a closed position 52, wherein the there is no significant gap between the door 50 and the housing 12 of the cage-type trap 10. Although, the embodiment of the cage-type trap 10 is depicted having only a single door 50, those in the art should recognize the embodiments of cage-type traps 10 may include multiple doors 50 operably located with the housing 12. For example, the closed end 40 of the housing 12 may include another door arranged similar to, but opposite the door 50. Embodiments of cage-type traps 10 may be used with both single or double door box traps. Double door non-directional cage-type traps 10 are effective because animals can be captured in a “blind” setting situation in a trail as they pass through the trap from either direction or in front of a dwelling exit such as the opening of a beaver lodge. Double door cage-type trap embodiments 10 may be readily used as single door traps useful in a baited situation, allowing for the second door to become a closed alternate bait door and making it easy to bait the trap from the rear behind the trigger without reaching all the way through the trap past the trigger actuator in order to place bait.

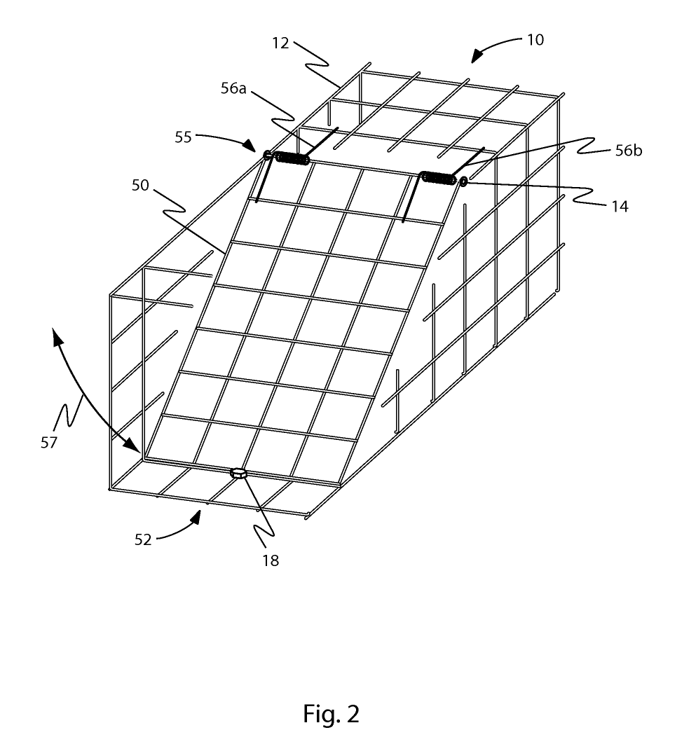

Referring further to the drawings, FIG. 2 depicts a partial cut-away perspective view of an embodiment of a door 50 of an embodiment a cage-type animal trap 10, the door 50 being in a closed position 52. As depicted, the door 50 is hinged on a pivot bar 14 of the housing 12 at a location 55. Thus the door 50 can swing up and down in a direction as shown by direction arrow 57. However, those in the art should appreciate that embodiments of a cage-type trap 10 may include doors operable in other ways, such as by sliding, scissoring, or radially expanding. Door 50 is depicted being hinged because of the typical usage in the art. Embodiments of a door 50 may be powered. For example, springs, such as coil springs 56a and 56b may be located so as to act upon the door 50 and the housing 12, thereby exerting a downward force on the door along the direction 57 toward the closed position 52. Hence, once triggered, embodiments of a door 50 may slam shut with the assistance of springs 56a-b. Once the door is located in a closed position, it may be secured by a nub latch 18 on the bottom of housing 12 to prevent unwanted opening of the door 50. Those in the art should recognize that various means may be employed to keep the door in a closed position 52. Moreover, various means may be employed to keep the door in an open position 54. For instance, a washer such as washer 59, a lip, or a simple structural element 58 of the door 54, may be designed to physically interact with a door release mechanism such as a latch feature or drop bar so that the door release mechanism can hold the door in the open position 54 until moved by a powered trigger mechanism as discussed further herein.

Embodiments of a powered trigger system, such as the trigger devices 90, 100, 200, 300 and 600 (shown in FIGS. 1, 4, and 7-9) may be provided to accommodate any trap embodiments 10 with power spring doors, such as door 50, ranging from weak to moderate to strongly powered door springs and or powered locking bars for fast and forced closing in both water or land conditions. As will be discussed further, power in the power trigger system embodiments may be designed in such a way so as to match and accommodate the tension or resistive force created by the strength in the door 50 and or lock bar springs as it relates to trigger tension so that no undue pressure is required to fire or actuate the trap 10 while providing enough power to overcome friction at the ends of the trap 10 and pull the door release mechanisms, such as latches or drop pins, to allow the door 50 to shut.

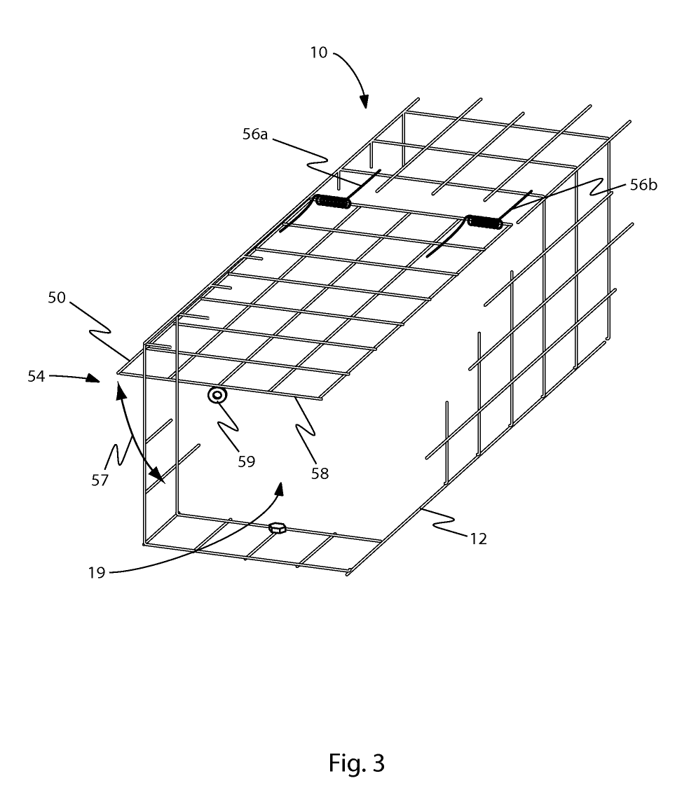

Further structure and action of embodiments of a door 50 is described in relation to FIG. 3, which depicts a partial cut-away side perspective view of an embodiment of a door 50 of an embodiment a cage-type animal trap 10, the door 50 being in an open position 54. When in an open position 54, the door 50 is swung up and against the top portion of housing 12. In this position, the springs 56a-b apply a continuous resistive force down along the direction 57. Therefore, an animal may freely enter into the interior volume 19 of the housing 12 of cage-type trap 10 without significant interference by the door 50 when it is in an open position 54. Because the springs 56a-b are pre-loaded, the door 50 may slam shut behind the animal when the animal actuates a trigger and the door is released from its open position 54 and moves to the close position 52 (shown in FIG. 2).

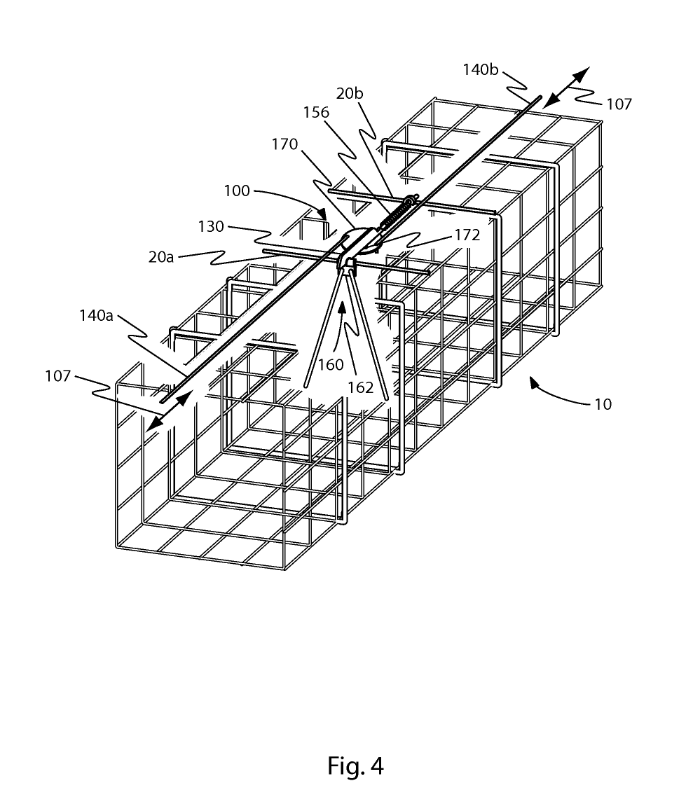

For purposes of clarity and simplicity, FIGS. 4 and 7-9 are shown with a substantial portion of the structural elements 20 of the cage housing 12 being cut-away. Accordingly, FIG. 4 depicts a cut-away side perspective view of a first embodiment 100 of a powered trigger apparatus of an embodiment of a cage-type animal trap 10. Significant structural elements 20a and 20b are shown. The trigger apparatus 100 includes a spring 156. The spring 156 is operable between a catch mechanism 130, such as a pawl or dog component, and a latch feature 140a and/or 140b, such as a drop rod or other like door release mechanism, to exert a force tending the latch feature 140a-b toward powered disengagement from the cage door, such as door 50 (see FIGS. 1-3) when the catch mechanism 130 is disengaged from a structural element of the cage 20a. The trigger apparatus 100 operates with a rotating wheel 170 connected by a pin 172 welded, or otherwise attached to the rear of the catch mechanism 130. The pin 172 is inserted into a hole on the rotating wheel 170. The latch features 40a-b are also connected to the wheel 170 so that when the trigger 100 is fired by movement of the actuator 160, the catch mechanism removes out of an engaged set state with a cam component of the actuator 160 and moves as the power spring 156 pulls the catch mechanism 130 backwards associatively turning the wheel 170 which in turn pulls the latch feature out from engagement with washers 59, or wire loops, which support the door 50 in a hung position in the set open position 54.

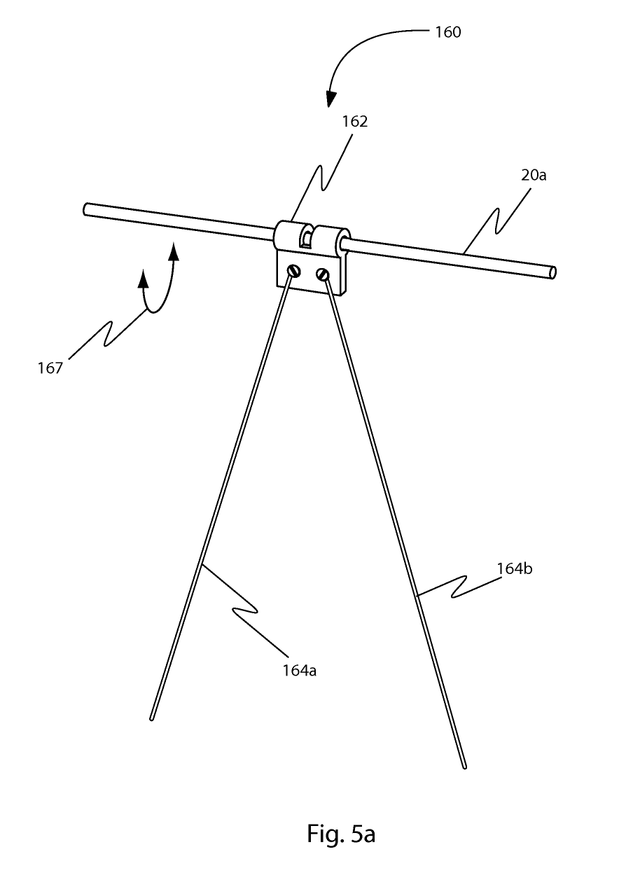

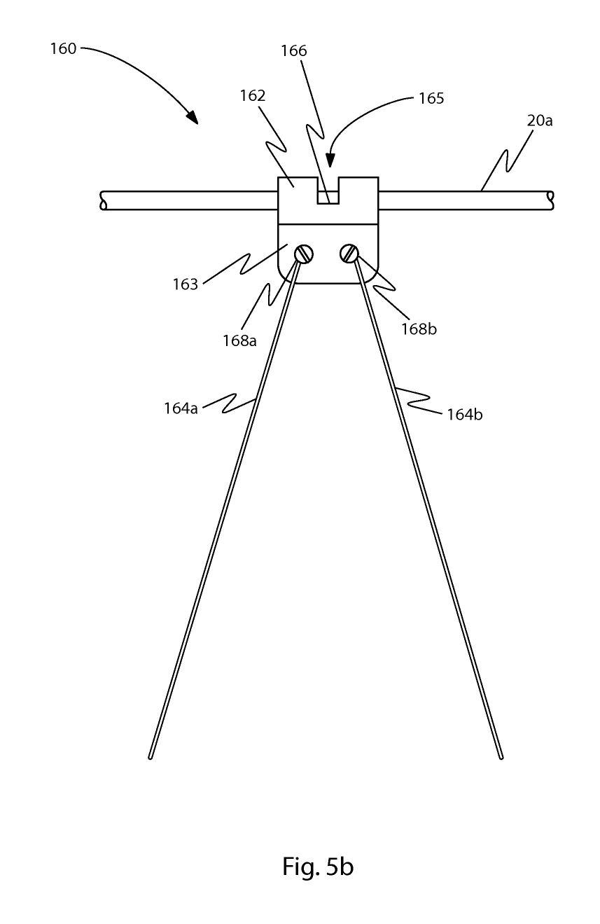

Referring to FIG. 5a, a side perspective view of an embodiment of an actuator 160 of an embodiment of a powered trigger apparatus 100 of an embodiment of a cage-type animal trap 10 (see FIG. 4) is depicted. The actuator 160 includes a wire member, such as wire 164a and/or 164b, which protrudes into the interior volume of the cage housing 12 of the trap 10 (see again, FIG. 4). The wire member(s) 164a-b are connected to a pivotal cam component 162. The cam component 162 is secured to and pivots around a structural element 20a of the cage housing 12 in a direction 167 as shown. Shown in more detail in the side view of FIG. 5b, is the saddle portion 165 of the cam component 162. The saddle portion is a notch or other feature formed into the body of the cam component 162 that is fashioned to physically engage a catch mechanism, such as catch mechanism 130, when the catch mechanism is located in a set position in the saddle 165 of the cam component 162. The saddle portion 165 includes shoulders 166 on either side so that as cam component pivots, a shoulder 166 raises up above its normal set position. Screws 168a-b, or other fastening means, may connect wire member(s) 164a-b to a plat portion 163 of the cam component 162.

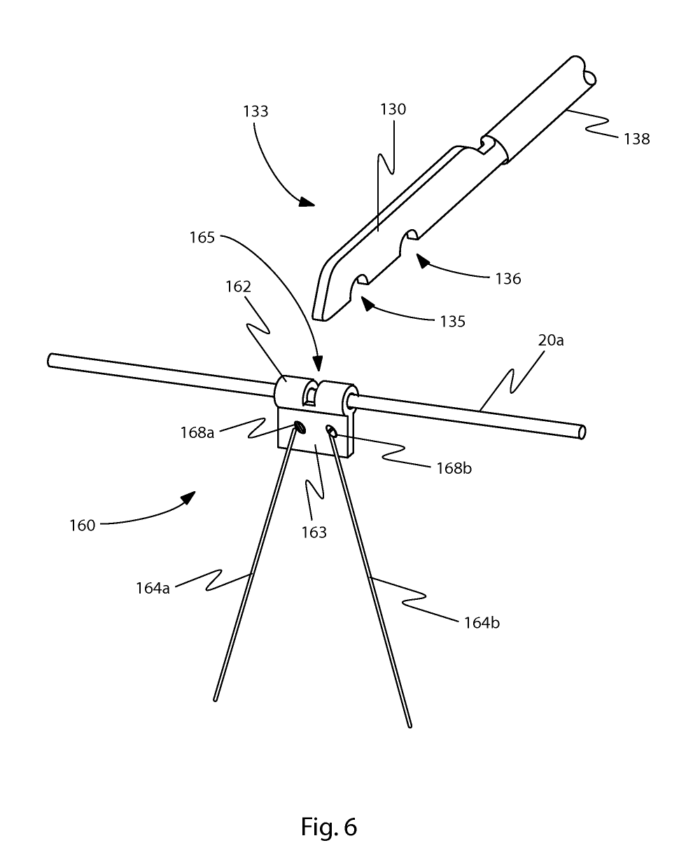

With continued reference to the drawings, FIG. 6 partial cut-away side perspective view of an embodiment of a catch mechanism 130 prior to positioning in a set state in engagement with an actuator 160 of an embodiment of a powered trigger apparatus 100 of an embodiment of a cage-type animal trap, such as trap 10 (see FIG. 4). A catch mechanism 130 may be configured to physically engage a structural element 20a of the cage, the catch mechanism 130 being in operable contact with the cam component 162 so that the catch mechanism 130 becomes disengaged from the structural element of the cage 20a when the wire member 164a-b is moved causing the cam component 162 to pivot and move the catch mechanism 130 out of its engaged position. The structural element of the cage 20a is a structural element of the actuator 160. The catch mechanism may be engaged with the saddle 166 of cam component 162 at either of notches 135 or 136 depending on design of other associated components such as movable latch features 140a or 140b shown in FIG. 4. The latch features may be configured to physically engage a portion of a door of the trap, such as the washer ring 59 of door 50 (shown in FIG. 3) to secure the door in an open position. The latch feature(s) 140a-b maybe operably connected to the catch mechanism 130 so that the latch feature(s) 140a-b become disengaged from the door(s) allowing the door(s) to close when the catch mechanism 130 becomes disengaged from the structural element 20a of the cage housing 12. Thus, the a trigger device 100 may be operable to release the door, such as door 50, from the open position 54 and permit movement of the door 50 to the closed position 52 (see FIG. 2). The spring 156 (see FIG. 4) may serve as a resilient force exerting member, operably positioned to exert a release force on the door release component, such as latch feature(s) 140a-b, through a connecting member 138, to speed up release of the door when the catch mechanism 130 is in a non-set position 133.

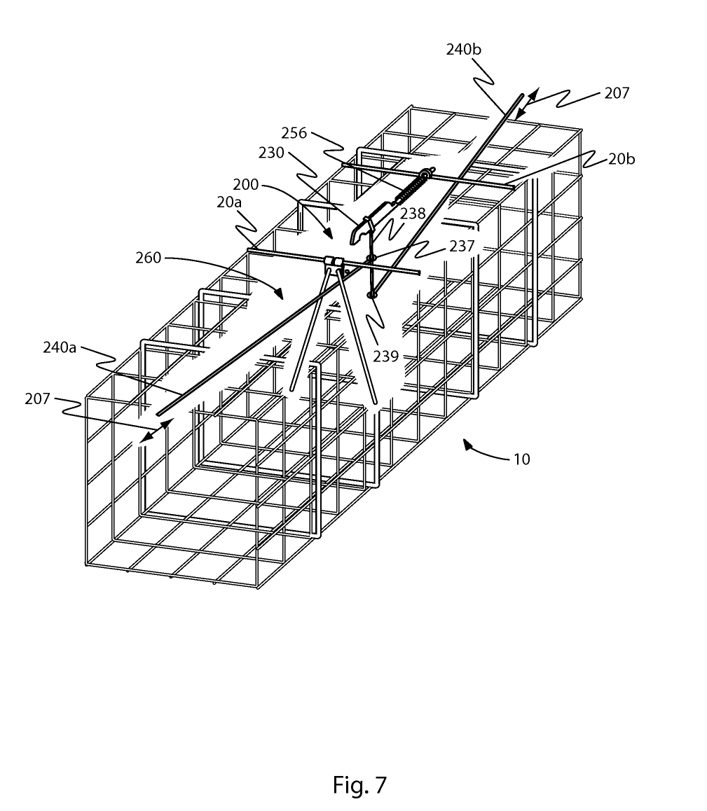

As described herein, various structural and functional similarities may exist between the embodiment of a powered trigger apparatus 100 and addition powered trigger apparatus embodiments 200, 300 and 600 discussed further below. For instance, cam components, wire members, and catch mechanisms, such as pawls or dog components, may be similar in design and operation. In particular, each of the embodiments of a powered trigger apparatus employs a spring or resilient member to exert a release force on a movable latch or door release component to power disengagement of the latch from the door speeding up free movement of the door when the catch mechanism is in the non-set state. Accordingly, FIG. 7 depicts a cut-away side perspective view of a second embodiment 200 of a powered trigger apparatus of an embodiment of a cage-type animal trap 10. The powered trigger apparatus 200 includes a pivoting extended trip arm 238 in order to gain a mechanical advantage over the small wheel 170 of embodiment 100 while supplying the same triggering principles used in embodiment 100. The trip arm 238 may pivotally connect with door release mechanisms 240a-b at locations 237 and 239. Because of the powered trigger apparatus 200 uses the trip arm 238 and spring 256 in tandem, there is enough power to pull the drop pin latches 240a-b back in such a way as to add no additional trigger pressure, allowing the trigger apparatus to function easily with little pressure required to fire the trap 10.

Powered trigger apparatus embodiment 200 operates with a double locking door system on two opposite doors. In the event a small stick (up to one inch in diameter) or debris becomes lodged between the door and cage floor when the trap is fired and the door moves to the closed position 54, a second system (not shown) will act as a back up and will relieve the first system keeping the door locked. The normal locking system number is powered by long expansion springs which hold a lock bar into place after the door has dropped completely to ground level. As stated if complete door closure does not occur, “flipper” latches from the secondary locking system (not shown) allow the door to pass them by. The flippers are “one way” and let the door go by only in a single downward direction. After the door passes the flippers gravity returns the flippers to their original position holding the door from raising back open because the latch can not move in the other direction. Hence, in that secondary closed position (not shown but described herein) if an animal attempts to raise the door it can not because of the one way action of the flippers which hold the door closed at no more than one inch from the bottom of the cage-type trap 10.

Multiple springs may power a door unit of a cage-type trap 10. For instance, one set of springs may be located on the doors 50 and another set on the lock bar may be placed on a lock bar or other structure operable with the cage housing 12 to keep the doors closed once shut in the closed position 52. The stronger pair of springs may be located on the doors 50, which are coil springs, such as springs 56a-b (see FIGS. 1-3) that remain pretty much relaxed in the unset position with only slight pressure on them when the door 50 is down and locked shut. The coil springs, such as springs 56a-b, become resistively activated when compressed by raising the door(s) 50 and placing the door(s) in the set open position 54. The coil springs 56a-b may be referred to as the “starter springs” which initiate door closing and offer the resistance to the drop pin latch features 240a-b at the friction engagement point at the ends of the trap 10.

A second set of expansion springs (not shown) may be located on a structural member such as a lock bar and may likewise be resistively activated in the set position open position 54 when the door is raised. Following actuation of the powered trigger apparatus 100, the second expansion springs may pull and hold the structural member such as a lock bar down onto the door keeping the doors closed while the doors are located in the closed position. Thus the secondary springs (not shown) are expanded and stretched when the trap is in the set position, thereby “loading” the secondary springs. A characteristic of the secondary springs lies in the fact that when the door 50 is in the set open position 54, the secondary springs lie horizontally and parallel to the door 50, applying no vertical pressure on the door 50. Thus, the trap 10 after the trigger device 200 is actuated, the doors are initially fired by the large starter coil springs 56a-b. Advantageously, force of the springs 56a-b does not assert undue pressure that can not easily be overcome by a the corresponding power trigger system 200. Furthermore, when the large door coil springs 56a-b begin to push the door closed, additional structural members like the formerly horizontal secondary expansion springs (not shown) are resistively activated and begin to move. Hence, as the door angle increases when the door 50 drops the secondary springs now begin to exert additional pressure onto the lock bar or other structural members which is then transferred to the door 50 while accelerating the velocity of the door 50 as the door 50 drops from the beginning of the closing until it is locked by the lock bar and door at the bottom in the closed position 52. The greatest closing speed of the door 50 occurs just prior to the point of impact when the door 50 makes contact with the bottom of the cag housing 12 of the trap 10.

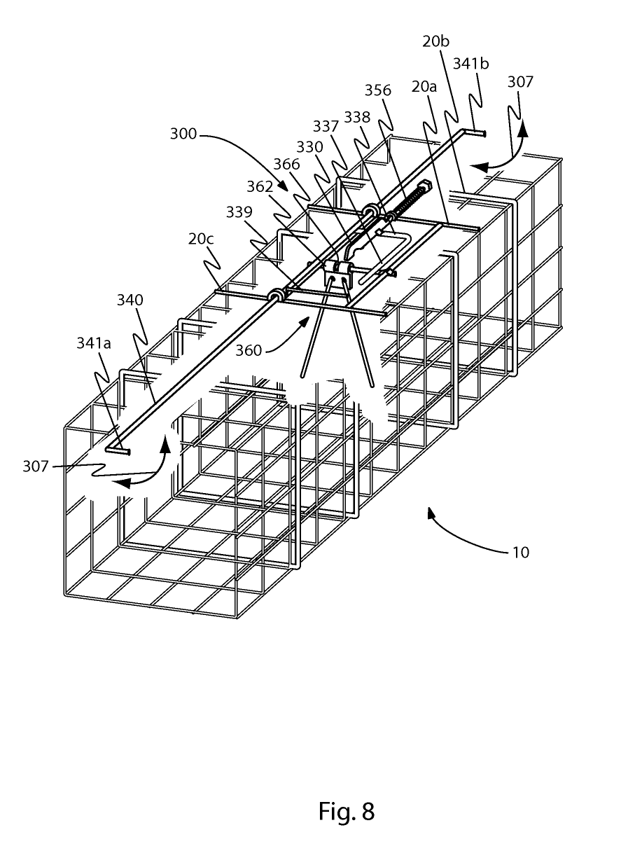

With additional reference to the drawings, FIG. 8 depicts a cut-away side perspective view of a third embodiment 300 of a powered trigger apparatus of an embodiment of a cage-type animal trap 10. The powered trigger apparatus 300 is designed to maneuver the drop pin latches 340a-b in a rotational direction 307, as opposed to the lateral movement of door closing mechanisms previously discussed. The powered trigger apparatus 300 utilizes a similarly functional system as found in all the previously described trigger apparatus embodiments: a wire cam actuator 360 moving a dog or catch mechanism 330 out of engagement with a structural element 20a with powered assistance from a spring 356 operable with the trigger apparatus 300. However, the powered trigger apparatus 300 employs a short drop rod structure 339 originating from unitary door release mechanism 340, which is connected to rod portions 337 and 338 to support the catch mechanism or “dog” portion 330. The dog 330 is placed into cam component 362 “saddle” 366 as in all cases in the set open door position. When the actuator 360 is activated, the pivoting cam component 362 forces the dog 330 to rises-up out of the “saddle” 366 and then retreat with the aid of a compression spring 356 pulling the rod 338 out from under a short nub holding the long single continuous drop rod door release mechanism 340 which runs the length of the trap 12. When the drop rod 340 rotates downward, both doors drop together as the short rods 341a-b on the drop rod 340 drop out from under washer, wire loops or other engagement components 59 affixed to the end of the doors 50 that help hold the doors 50 up in the set open position 54.

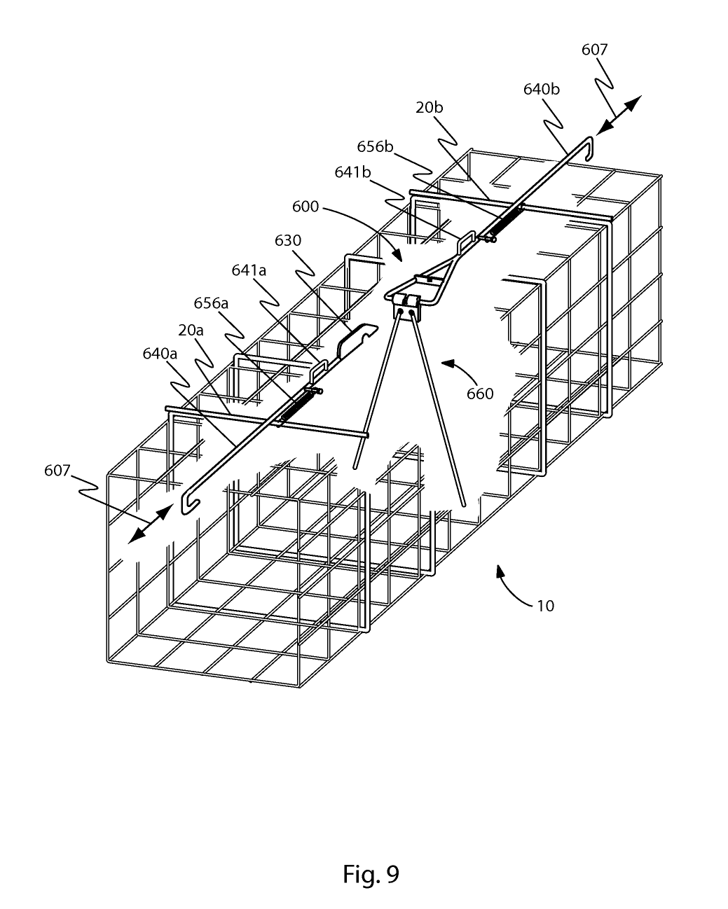

Continuing with further reference to the drawings, FIG. 9 depicts a cut-away side perspective view of a fourth embodiment 600 of a powered trigger apparatus of an embodiment of a cage-type animal trap 10. The powered trigger apparatus 600 includes two opposing door release mechanisms or rods 640a and 640b. At the end of each rod 640a-b is a latch hook 641a-b that can securely retain a door, such as door 50 (see FIGS. 1-3) in an open position 54. Similar with the other powered trigger apparatus discussed herein, a catch mechanism 630, such as a dog or pawl, may sit in an engaged set position with a cam component 662 of a trigger actuator 660. Springs 656a-b corresponding to rods 640a-b, operate with associative spring hold elements 642a-b respectively attached to rods 640a-b and are connected to applicable structural elements 20a and 20b of the trap 10. The springs 656a-b tend to pull the catch mechanism 630 and associated rods 640a-b away from each other, thereby allowing each rod to extend in a direction 607 outward away from the ends of the cage-type trap 10. Hence, when the latch hooks 641a-b of the rods 640a-b are moved far enough outward away from the door(s) 50, then the door(s) 50 become free to move from a set open position 54 to a non-set closed position 52 thereby closing the cage-type trap.

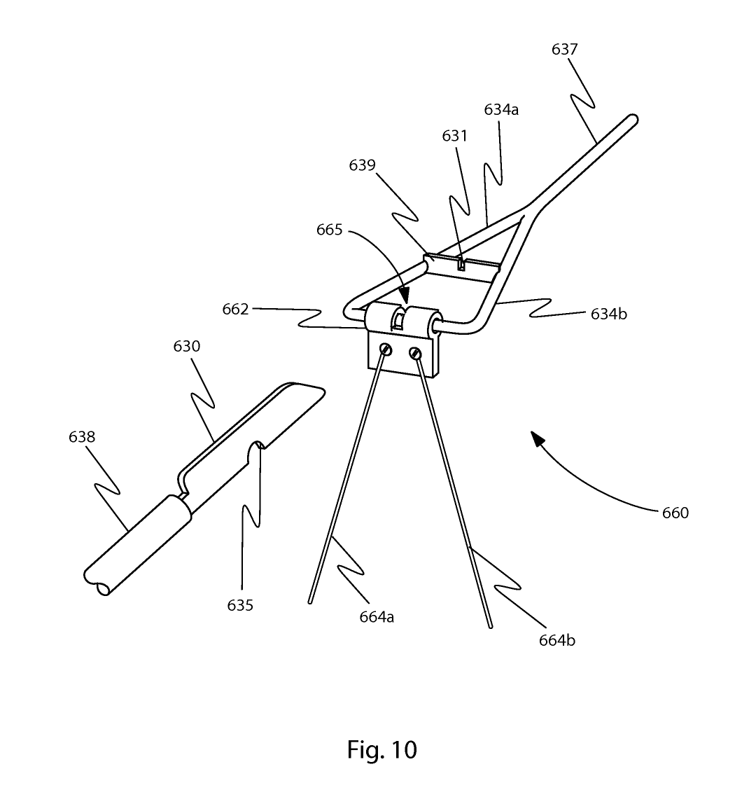

Further detail is revealed in FIG. 10, which depicts a partial cut-away side perspective view of an embodiment of a catch mechanism 630 prior to positioning in a set state in engagement with an actuator 660 of the fourth embodiment 600 of a powered trigger apparatus of an embodiment of a cage-type animal trap 10. The structural element of the cage that the catch mechanism 630 engages is a perpendicular member 636 forming a base of a triangle structure having side rods 634a and 634b and being connected to the end of the rod 640b. The triangle component including rods 636 and 634a-b forms part of the actuator 660. As before, a notch 635 of the catch mechanism 630 rests in the saddle 665 of a cam component 662. A spacer member 639 having a slot 631 is provided to orient the catch mechanism 630 when it is in a set position. Grips 643a-b help pull the rods 640a-b together to help orient elements in a set state.

When these rods 640a-b are connected together at the center by a dog 630 and a and triangle part of the actuator 660 to form a single unit this unit has a “free floating action”, which allows the doors 50 to be latched quite easily merely by pulling one end of the rod in an outward direction until the hook 641a-b clears the end of the door 50, at which time the door 50 is raised just slightly above the hook 641a-b. Then the hook at the end of the rod is released and the door 50 dropped onto the hook 641a-b supporting the door in the set position, the process is repeated at the other end of the trap for door number two until both doors are set, the only important factor in this is that enough play is maintained in the one continuous bar between the hooks at the end so that it can be slid back and forth with enough clearance for the hooks to pass by the doors as they are lifted into the set position to be latched at either end.

Critical is that these two rods 640a-b when connected act as a solid unit with little play because the setting process can twist one rod out of alignment with the other thus activating the trigger, on the end of the dog rod is a flat piece of one half inch wide by one eighth piece of steel about one inch long which seats into a slotted second piece of flat stock on the trigger portion on rod number two thus connecting the two rods, the slotted piece is welded behind the trigger allowing the male end of the dog portion to fit into the slot creating a “solid” continuous rod from one end of the trap to the other adding stability to the unit while nearly eliminating the chances for a twisting action which would unseat the dog causing premature firing.

A method of using a cage trap to catch an animal is described with reference to FIGS. 1-10. The method includes providing a cage trap 10, having movable door 50 sized to permit entry of an animal into the cage trap 10 when the door 50 is in an open position 54, wherein the cage trap 10 includes a triggering apparatus 90, 100, 200, 300, 600 including: an actuator 160, 260, 360, 660, protruding into the interior volume of the cage trap 10; a catch mechanism 130, 230, 330, 630, configured to physically engage a structural element of the cage trap in a set state, the catch mechanism 130, 230, 330, 630, being in operable contact with the actuator 160, 260, 360, 660 so that the catch mechanism becomes disengaged from the structural element of the cage trap when the actuator is moved causing the catch mechanism to move to a non-set state; a movable latch 140, 240, 340, 640, configured to physically engage a portion of a door of the cage trap to secure the door 50 in an open position 50, the latch 140, 240, 340, 640operably connected to the catch mechanism so that the latch becomes disengaged from the door allowing the door to close when the catch mechanism is in the non-set state; and a spring, operably positioned to exert a release force on the latch to power disengagement of the latch from the door speeding up free movement of the door when the catch mechanism is in the non-set state; allowing an animal to enter the cage trap; and capturing the animal when the animal contacts the actuator thereby initiating the trigger, wherein the contacted actuator moves the catch mechanism to a non-set state and the connected latch quickly releases the door as the spring exerts a release force causing the latch to forcibly disengage and speedily allow the door to freely close thereby shutting the animal inside the cage trap.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims. The claims provide the scope of the coverage of the invention and should not be limited to the specific examples provided herein.

1. A cage-type animal trap powered trigger apparatus comprising:
a wire member, protruding into the interior volume of a cage;
a pivotal cam component, connected to the wire member;
a catch mechanism, configured to physically engage a structural element of the cage, the catch mechanism being in operable contact with the cam component so that the catch mechanism becomes disengaged from the structural element of the cage when the wire member is moved causing the cam component to pivot and move the catch mechanism out of its engaged position;
a movable latch feature, configured to physically engage a portion of a door of the trap to secure the door in an open position, the latch feature operably connected to the catch mechanism so that the latch feature becomes disengaged from the door allowing the door to close when the catch mechanism becomes disengaged from the structural element of the cage; and
a spring, operable between the catch mechanism and the latch feature to exert a force tending the latch feature toward powered disengagement from the cage door when the catch mechanism is disengaged from the structural element of the cage.

2. A cage-type animal trap comprising:
a cage, having an interior volume;
a door of the cage, the door movable between an open position and a closed position; and
a trigger device, operable to release the door from the open position and permit movement of the door to the closed position, the trigger device including:
a movable door release component, configured to hold the door in the open position;
an actuator, wherein a portion of the actuator resides within the interior volume of the cage;
a catch mechanism, operably connected to the door release component to move the door release component when the actuator moves the catch mechanism to non-set position; and
a resilient force exerting member, operably positioned to exert a release force on the door release component to speed up release of the door when the catch mechanism is in the non-set position.

3. A method of using a cage trap to catch an animal, the method comprising:
providing a cage trap, having a movable door sized to permit entry of an animal into the cage trap when the door is in an open position, wherein the cage trap includes a triggering apparatus including:
an actuator, protruding into the interior volume of the cage trap;
a catch mechanism, configured to physically engage a structural element of the cage trap in a set state, the catch mechanism being in operable contact with the actuator so that the catch mechanism becomes disengaged from the structural element of the cage trap when the actuator is moved causing the catch mechanism to move to a non-set state;
a movable latch, configured to physically engage a portion of a door of the cage trap to secure the door in an open position, the latch operably connected to the catch mechanism so that the latch becomes disengaged from the door allowing the door to close when the catch mechanism is in the non-set state; and
a spring, operably positioned to exert a release force on the latch to power disengagement of the latch from the door speeding up free movement of the door when the catch mechanism is in the non-set state;
allowing an animal to enter the cage trap; and
capturing the animal when the animal contacts the actuator thereby initiating the trigger, wherein the contacted actuator moves the catch mechanism to a non-set state and the connected latch quickly releases the door as the spring exerts a release force causing the latch to forcibly disengage and speedily allow the door to freely close thereby shutting the animal inside the cage trap.

4. The powered trigger apparatus of claim 1, further comprising a second movable latch feature configured to physically engage a portion of a second door of the trap to secure the second door in an open position, the second latch feature operably connected to the catch mechanism so that the latch feature becomes disengaged from the second door allowing the second door to close when the catch mechanism becomes disengaged from the structural element of the cage.

5. The powered trigger system of claim 1, wherein the movable latch feature moves in a linear direction toward the interior volume of the cage to release the door when the triggered spring powers disengagement.

6. The powered trigger system of claim 1, wherein the movable latch feature moves in a rotational direction to release the door when the triggered spring powers disengagement.

7. The powered trigger system of claim 1, wherein the movable latch feature moves in a linear direction away from the interior volume of the cage to release the door when the triggered spring powers disengagement.

8. The powered trigger system of claim 1, wherein the door closes by rotating about a hinge.

9. The powered trigger system of claim 1, wherein the door closes by linearly sliding shut.

10. The cage-type animal trap of claim 2, further comprising a second door movable between an open position and a closed position.

11. The cage-type animal trap of claim 10, wherein the trigger device is operable to release both doors from the open position and permit movement of both doors to the closed position.

12. The cage-type animal trap of claim 11, wherein the doors are spring powered to assist movement of the doors from the open to the closed position.

13. The cage-type animal trap of claim 12, wherein the trigger device is matched to accommodate the tension or resistive force created by the strength powered doors so that no undue pressure is required to actuate the trigger while also providing enough power to overcome friction at the ends of the trap and move the door release components to allow the doors to shut.

14. The cage-type animal trap of claim 2, wherein the resilient force exerting member is an adjustable compression spring.

15. The cage-type animal trap of claim 2, wherein the resilient force exerting member is an expandable spring.

16. The cage-type animal trap of claim 2, wherein the actuator includes a wire member extending into the interior volume of the cage, and a pivotal cam component connected to the wire member.

17. The method of using a cage trap to catch an animal of claim 3, wherein the cage trap further comprises a second similarly sized movable door.

18. The method of using a cage trap to catch an animal of claim 17, wherein the cage trap is a double door non-directional trap and the animal is captured by placing the trap in a “blind” setting situation.

19. The method of using a cage trap to catch an animal of claim 17, wherein the cage trap is a double door non-directional trap used as single door trap, wherein the second door is a closed alternate bait door making it easy to bait the trap from the rear behind the trigger actuator without reaching all the way through the trap past the trigger actuator in order to place bait.

20. The method of using a cage trap to catch an animal of claim 3, wherein the cage and the triggering device are sized according to the size of the intended animal to be captured.
